(19) United States
(12) Patent Application Publication
(10) Pub. No.: US 2026/0258769 A1
(43) Pub. Date: Sep. 3, 2026

(54) SOUND ABSORPTION DEVICE

(71) Applicant: Safran Nacelles, Gonfreville-L’orcher (FR)

(72) Inventors: François BELLET, Moissy-Cramayel (FR); Julien CHANDELIER, Moissy-Cramayel (FR); Damien LEMOINE, Moissy-Cramayel (FR); Fabien JOURDAN, Moissy-Cramayel (FR)

(73) Assignee: Safran Nacelles, Gonfreville-L’orcher (FR)

(21) Appl. No.: 18/839,893

(22) PCT Filed: Feb. 22, 2023
(86) PCT No.: PCT/FR2023/050249

§ 371 Date: Aug. 20, 2024

(30) Foreign Application Priority Data
Feb. 23, 2022 (FR) FR2201598

(51) Int. Cl. F02K 1/82; B64D 29/00; B64D 33/02; F02K 1/62

(52) U.S. Cl. CPC F02K 1/827; B64D 29/00; B64D 33/02; F02K 1/62; B64D 2033/0206

(57) ABSTRACT

An assembly including a duct that guides an air flow, a beam that supports a movable element of a thrust reverser of an aircraft engine, the beam including a wall delimiting cavities opened to the air flow, and an acoustic fairing. The fairing includes a cover and partitions secured to the cover. The acoustic fairing is to be added and fixed onto the beam so that the cover delimits a portion of the duct by obturating the cavities, and so that each of the partitions extends within one of the cavities so that the acoustic fairing and the beam delimit plural acoustic cells that absorb an acoustic wave propagating from the air flow. Once the acoustic fairing is added and fixed onto the beam, the first layer obturates the cavities and the second layer delimits the portion of the duct.

### FIELD OF THE INVENTION

The present invention relates to a propulsion assembly comprising an aircraft engine and a sound absorption device.

### STATE OF THE ART

The operation of some aircraft propulsion assemblies involves the air flow which has high flow rates, sometimes resulting in noise pollution that it is desirable to reduce.

### DISCLOSURE OF THE INVENTION

One aim of the invention is to reduce noise pollution related to the operation of a propulsion assembly for an aircraft.

To this end, it is proposed, according to one aspect of the invention, an assembly for an aircraft engine comprising:
a duct configured to guide an air flow;
a beam provided to support a movable element of a thrust reverser of the engine, the beam comprising a wall delimiting a plurality of cavities opened to the air flow; and
an acoustic fairing comprising:
   an acoustically porous cover; and
   a plurality of partitions secured to the cover;
the acoustic fairing being provided to be added and fixed onto the beam so that the cover delimits part of the duct by obturating the cavities and so that each partition extends within a cavity, so that the acoustic fairing and the beam delimit a plurality of acoustic cells configured to absorb an acoustic wave propagating from the air flow.

Advantageously, but optionally, the assembly according to the invention can comprise the at least one among the following characteristics, taken alone or in combination:
at least one passage is arranged passing through the cover so that, once the acoustic fairing has been added and fixed onto the beam, the acoustic wave can propagate from the air flow into at least one acoustic cell;
the cover comprises a rigid portion;
the cover comprises a flexible portion;
the cover comprises:
   a rigid layer in which a plurality of through orifices is arranged; and an acoustically porous flexible layer superimposed on the rigid layer;
in which, once the acoustic fairing has been added and fixed onto the beam, the rigid layer obturates the cavities and the flexible layer delimits the part of the duct;
the cover and at least one partition are in one piece;
at least one partition is added and fixed onto the cover;
at least one partition is acoustically porous;
it further comprises another acoustic fairing comprising another acoustically porous cover and a plurality of other partitions secured to the other cover, the other acoustic fairing being provided to be added and fixed onto the beam so that the other cover partially obturates a cavity and that the partitions extend within the cavity, the acoustic fairing being provided to be added and fixed onto the beam so as to be superimposed on the other acoustic fairing; and
it further comprises an aircraft engine, the engine comprising another wall delimiting another part of the duct.

### DESCRIPTION OF THE FIGURES

Other characteristics, aims and advantages of the invention will emerge from the following description, which is purely illustrative and not limiting, and which should be read in relation to the appended drawings in which:

FIG. 1 is a schematic sectional view of an aircraft propulsion assembly in a direct thrust configuration.

FIG. 2 is a schematic sectional view of the propulsion assembly of FIG. 1 in another thrust reversal configuration.

FIG. 3 is a schematic perspective view of part of a propulsion assembly in a thrust reversal configuration.

FIG. 4 is a schematic perspective view of part of a sound absorption device comprising a beam.

FIG. 5 is a schematic perspective view of another part of a sound absorption device comprising an insert forming an acoustic fairing.

FIG. 6 is a schematic perspective view of an assembly of the parts of the sound absorption device illustrated in FIG. 4 and in FIG. 5.

FIG. 7 is a schematic sectional view of a sound absorption device comprising two absorption stages.

FIG. 8 is a schematic sectional view of another sound absorption device comprising two absorption stages.

In all the figures, the similar elements bear identical references.

### DETAILED DESCRIPTION OF THE INVENTION

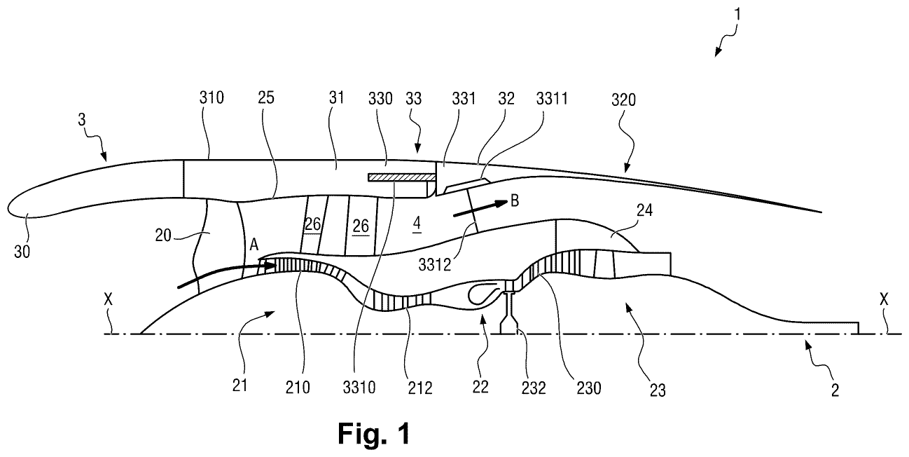

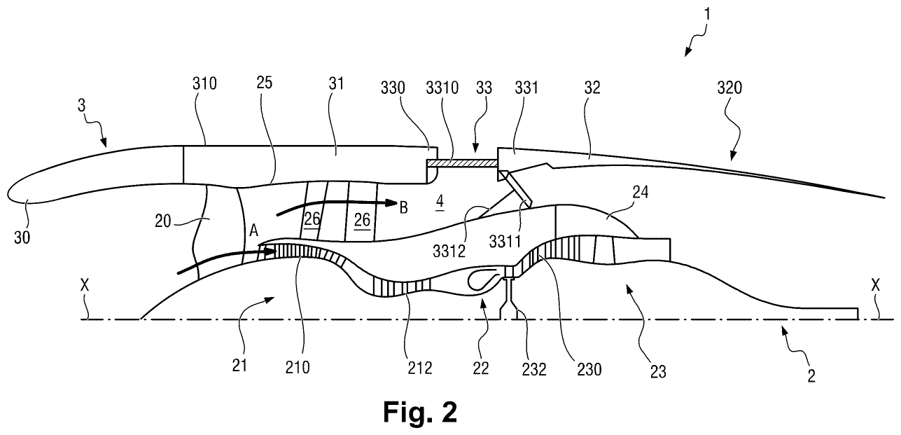

FIG. 1 and FIG. 2 illustrate a propulsion assembly 1 having a longitudinal axis X-X, and comprising an engine 2 (or turbomachine) and a nacelle 3 surrounding the engine 2.

The propulsion assembly 1 is intended to be mounted on an aircraft (not represented), such as an airplane or a helicopter, for example under the wing of the aircraft, on the wing or at the rear of the fuselage of the aircraft. In this regard, the propulsion assembly 1 can comprise a mast (not represented) intended to connect the propulsion assembly 1 to part of the aircraft.

The engine 2 illustrated in FIG. 1 and in FIG. 2 is a two-spool direct-drive turbofan engine. This is however not limiting since the engine 2 can include a different number of spools and/or streams, and/or be another type of turbojet engine, such as a geared turbofan or a turboprop.

Unless otherwise specified, the terms “upstream” and “downstream” are used with reference to the overall direction of gas flow through the propulsion assembly 1 in operation. Likewise, an axial direction corresponds to the direction of the longitudinal axis X-X and a radial direction is a direction perpendicular to the longitudinal axis X-X and intersecting the longitudinal axis X-X. Moreover, an axial plane is a plane containing the longitudinal axis X-X and a radial plane is a plane perpendicular to the longitudinal axis X-X. A circumference is understood as a circle belonging to a radial plane and whose center belongs to the longitudinal axis X-X. A tangential or circumferential direction is a direction tangent to a circumference: it is perpendicular to the longitudinal axis X-X but does not pass through the longitudinal axis X-X. Finally, the adjectives “internal” (or “inner”) and “external” (or “outer”) are used with reference to a radial direction so that the internal part of an element is, in a radial direction, closer of the longitudinal axis X-X than the external part of the same element.

As visible in FIG. 1, and in FIG. 2, the engine 2 comprises, from upstream to downstream, a fan 20, a compressor section 21 comprising a low-pressure compressor 210 and a high-pressure compressor 212, a combustion chamber 22 and a turbine section 23 comprising a high-pressure turbine 232 and a low-pressure turbine 230. The fan 20, the low-pressure compressor 210, and the low-pressure turbine 230 are connected together by a low-pressure shaft (not represented) extending along the longitudinal axis X-X to form a low-pressure spool. The high-pressure compressor 212 and the high-pressure turbine 232 are connected together by a low-pressure shaft (not represented) extending along the longitudinal axis XX to form a high-pressure spool. As visible in FIG. 1 and in FIG. 2, the compressor section 21, the combustion chamber 22 and the turbine section 23 are surrounded by a motor casing 24, while the fan 20 is surrounded by a fan casing 25. The motor casing 24 and the fan casing 25 are connected together by structural arms 26. The longitudinal axis X-X forms an axis of rotation for the fan 20, the rotor part of the compressor section 21 and the rotor part of the turbine section 23, which are capable of being driven in rotation about the longitudinal axis X-X relative to the motor casing 24 and to the fan casing 25.

The nacelle 3 extends radially outside the engine 2, all around the longitudinal axis X-X, so as to surround both the fan casing 25 and the motor casing 24, and to define, with a downstream part of the motor casing 24, a downstream part of a secondary path B, the upstream part of the secondary path B being defined by the fan casing 25 and an upstream part of the motor casing 24. The nacelle 3 comprises an upstream section 30 forming an air inlet for the fan 20, an intermediate section 31 which includes fan cowls 310 covering the fan casing 25, and a downstream section 32 comprising movable cowls 320. This is however not limiting, since the upstream section, the intermediate section and the downstream section can be in one piece, surrounding both the fan casing and the motor casing, so as to define the secondary path. This case occurs in particular when, unlike the nacelle 3 illustrated in FIG. 1 and in FIG. 2, the nacelle does not comprise a thrust reverser and only forms a nozzle for the air stream circulating through the secondary path.

In operation, the fan 20 sucks an air stream whose portion circulating within a primary path A is successively compressed within the compressor section 21, ignited within the combustion chamber 22 and expanded within the turbine section 23 before being ejected out of the engine 2. The primary path A passes right through the motor casing 24. Another portion of the air stream circulates within the secondary path B which takes an annular shape surrounding the motor casing 24. In this way, the propulsion assembly 1 generates a thrust. This thrust can for example be used for the benefit of the aircraft onto which the propulsion assembly 1 is added and fixed.

The secondary path B forms a duct 4 configured to guide an air flow through the propulsion assembly 1. Each of the engine 2, and more specifically each of the fan casing 25 and of the motor casing 24, and of the nacelle 3 comprises a wall delimiting part of the duct 4. Each wall is thus exposed to the air flow, that is to say it has a surface in contact with the air flow.

As visible in FIG. 1 and in FIG. 2, the nacelle 3 further comprises a thrust reverser 33 comprising a fixed structure 330, secured to the fan casing 25, and a movable structure 331 relative to the fixed structure 330. When the thrust reverser 33 is a cascade reverser thrust, as illustrated from FIG. 1 to FIG. 3, the movable structure 331 of the thrust reverser 33 comprises a plurality of cascade vanes 3310, the movable cowls 320, obturation flaps 3311 and connecting rods 3312 making it possible to actuate the obturation flaps 3311. The fixed structure 330 comprises, for its part, a beam (not represented) provided to support at least one element of the movable structure 331, typically at least one of the movable cowls 320.

FIG. 1 illustrates the thrust reverser 33 in a direct thrust configuration. In this configuration, the movable structure 331 is in a closed position in which the movable cowls 320 are bearing on the fixed structure 330, preferably bearing on a plurality of beams. In this closed position, the cascade vanes 3310 are housed in a space delimited radially by the fan casing 25 and by the fan cowls 310. In direct thrust configuration, the obturation flaps 3311 are retracted within a cavity formed by the movable cowls 320. The reverser thus makes it possible to channel the air stream within the secondary path B, towards the rear of the propulsion assembly 1, so as to generate a thrust. Thus, in FIG. 1, the cascade vanes 3310 and the movable cowls 320, which are axially secured to each other, are represented in a forward position.

FIG. 2 illustrates the thrust reverser 33 in a thrust reversal configuration. In this configuration, the movable structure 331 is in an open position in which the movable cowls 320 are longitudinally distant from the fixed structure 330 so as to define a radial opening of the secondary path B. The cascade vanes 3310 extend through this radial opening. In this thrust reversal configuration, the obturation flaps 3311 are deployed radially in the secondary path B so as to direct the air stream circulating within the secondary path B towards the cascade vanes 3310 which make it possible to orient the air stream is thus redirected towards the front of the propulsion assembly 1 in order to generate a counter-thrust. Thus, in FIG. 2, the cascade vanes 3310 and the movable cowls 320 of the movable structure 331 are represented in a rearward position.

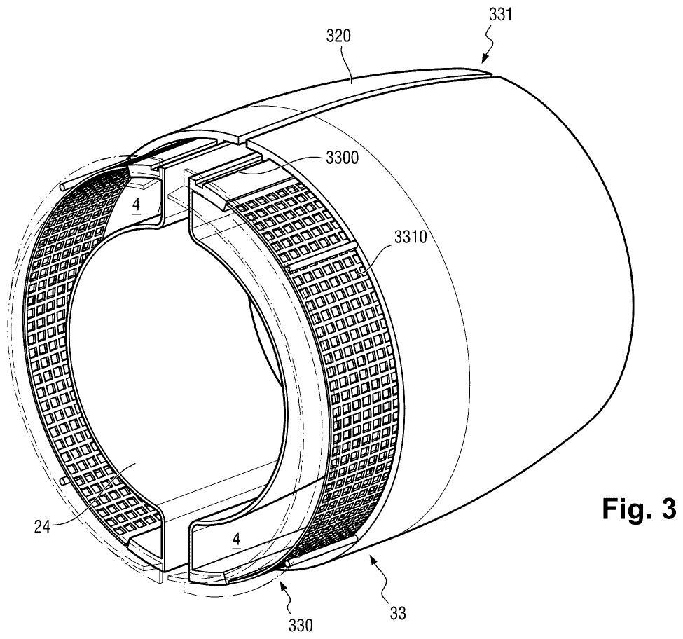

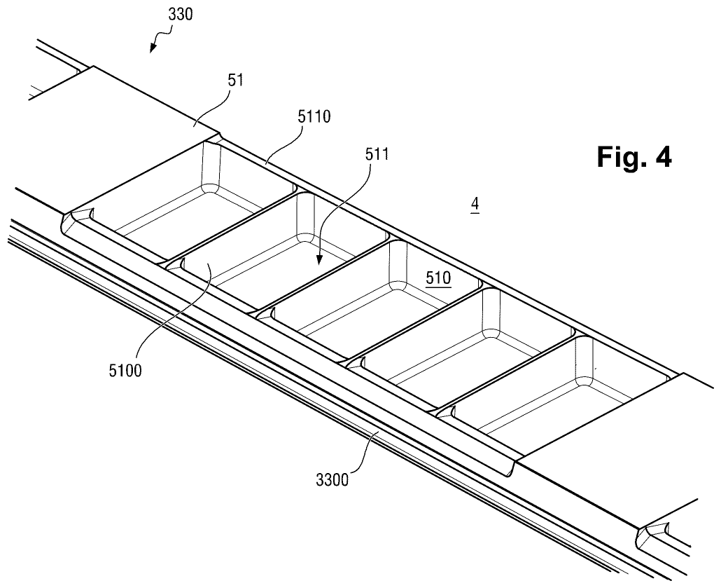

FIG. 3 illustrates part of a thrust reverser 33 according to another embodiment in which the cascade vanes 3310 belong to the fixed structure 330, the thrust reverser 33 being in a thrust reversal configuration. In FIG. 3, the elements housed inside the motor casing 24 have been omitted for the sake of clarity. As visible in FIG. 3, the fixed structure 330 of the thrust reverser 33 comprises guide elements 3300 of the movable cowls 320 during their displacement between the forward position and the rearward position. Typically, these guide elements 3300 comprise at least one rail 3300 extending axially, the rail 3300 being connected in a secured manner to the fan casing (not represented in FIG. 3) to the extent that the rail 3300 is provided within a beam of the fixed structure 330. In FIG. 3, the rail 3300 is arranged at the level of a radially outer surface of the fixed structure 330. This is however not limiting since the rail can also be arranged at the level of a circumferential edge of the fixed structure 330, as illustrated in FIG. 4 to FIG. 8. FIG. 3 illustrates that the cascade vanes 3310 follow each other along a circumferential direction, by being grouped into two lateral assemblies, each comprising several cascade vanes 3310, and each extending over an angular sector. The two lateral assemblies of cascade vanes 3310 are laterally spaced apart from each other at the level of their facing ends in pairs, to arrange upper and lower spaces respectively dedicated to the passage of the mast and of a lower longitudinal beam (not represented).

In other embodiments (not represented), the thrust reverser is a door-type thrust reverser. In this case, the movable structure comprises doors pivoting around pivots fixed to the fixed structure. In direct thrust configuration, the doors are integrated into the nacelle and delimit part of the duct so as to channel the air stream within the secondary path, towards the rear of the propulsion assembly, so as to generate a thrust. In a thrust reversal configuration, the downstream portion of the doors obturates the air stream circulating within the secondary path so as to force it to circulate through the orifice thus created through the nacelle. The upstream portion of the doors is generally provided with a deflector spoiler to redirect the air stream thus ejected from the nacelle towards the front of the propulsion assembly, with the aim of generating a counter-thrust.

Different embodiments of a sound absorption device 5 arranged at the level of at least one beam 51 provided with a rail 3300 of the fixed structure 330 of the thrust reverser 33 are illustrated from FIG. 4 to FIG. 8.

The sound absorption device 5 comprises a duct wall 50 delimiting part of the duct 4 of the secondary path B. This duct wall 50 being in contact with the air flow, it can be useful to acoustically treat it in order to limit the noise pollution associated with the air flow during the operation of the propulsion assembly 1. This treatment consists in particular in making the duct wall 50 acoustically porous, that is to say in modifying it so as to make it permeable to at least one acoustic wave, which is thus able to propagate through the duct wall 50 without being altered (or modified) at the passage of the duct wall 50.

As illustrated in FIG. 4, the sound absorption device 5 comprises a beam 51 forming a structural part, the beam 51 comprising a wall 510 delimiting at least one open cavity 511, preferably a plurality of open cavities 511, the cavities 511 being able to take any shape, such as a parallelepiped or hexagonal shape. In the embodiment illustrated from FIG. 4 to FIG. 6, the cavity 511 is opened to the air flow of the duct 4. Even, the wall 510 comprises several parts, which are in fact stiffeners 5100 of the beam 51, delimiting the plurality of open cavities 511. The cavities 511 can be obtained by machining the beam 51 in its thickness, or by molding, or even by additive manufacturing. Furthermore, the wall 510 has an edge 5110.

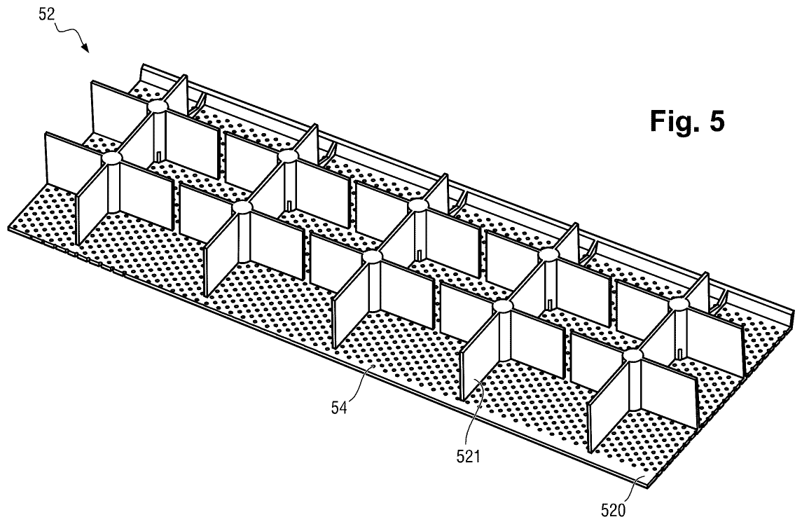

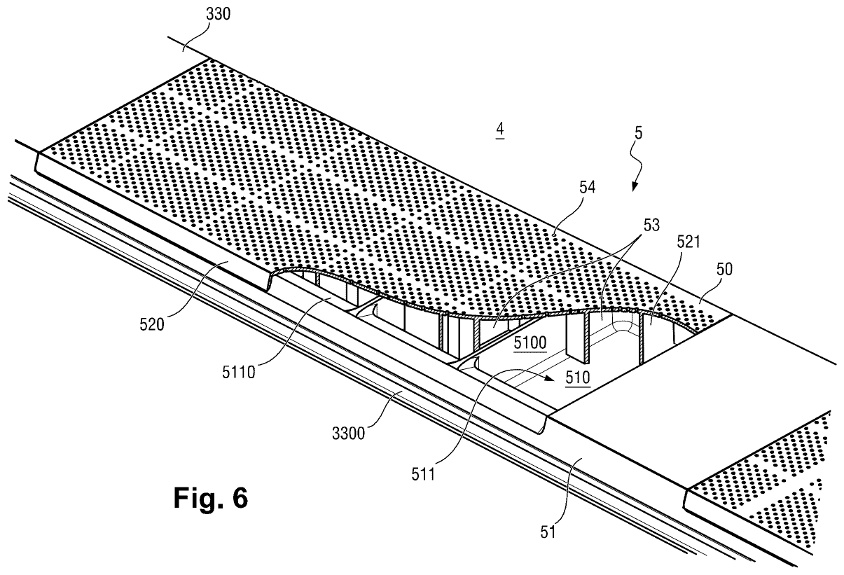

The sound absorption device 5 further comprises an insert 52, visible in FIG. 5, which forms an acoustic fairing and comprises an acoustically porous cover 520 and at least one partition 521 secured to the cover. The insert 52 can comprise any type of suitable material, such as a thermoplastic material, the cover 520 being able to be made of composite, metal or thermoplastic material. In this embodiment, as visible in FIG. 5, the partition 521 and the cover 520 are in one piece, that is to say they form an integral part with each other, typically by molding, thermocompression, additive manufacturing or by all appropriate types of machining, which makes it possible to facilitate the manufacture of the insert 52. In this embodiment, the insert 52 comprises a plurality of partitions 521, some partitions 521 being connected to each other. FIG. 6 illustrates that the insert 52 is added and fixed onto the support 51 so that the cover 520 closes (or obturates) at least part of the cavity 511, or even all the cavities 511, and so that the partition 521 is positioned inside the cavity 511 so as to separate the cavity 511 into at least two distinct closed cells 53 (or alveoli). In this way, each cell 53 is delimited by at least part of the wall 510 and at least part of the partition 521. As visible in FIG. 6, the duct wall 50 is thus formed by at least part of the cover 520. In fact, the insert 52 is added and fixed onto the beam 51 so that the cover 520 delimits part of the duct 4 by obturating the cavities 511 and so that each partition 521 extends within a cavity 511, so that the insert 52 and the beam 51 delimit a plurality of cells 53, which are in fact acoustic cells 53 configured to absorb an acoustic wave propagating from the air flow. More specifically, the cells 53 form a resonance box for the air sucked from the air flow which is trapped there, which makes it possible to attenuate the sound emissions related to the air flow within the propulsion assembly 1 in operation. In other words, the sound absorption device 5 takes advantage of the structure of the beam 51, in particular of the stiffeners 5100, to form cells 53 forming an array of Helmholtz resonators thanks to the supply of the cover 520 and of the partitions 521 of the insert 52. The insert 52 can be fixed to the support 51 by any means, typically thanks to cage nuts or mechanical inserts (not represented). In the embodiment illustrated in FIG. 6, the cover 520 is even flush with the edge 5110 of the wall 510 of the beam 51 so as to close the cavity 511 and form the duct wall 50, which makes it possible to limit the aerodynamic losses at the level of the sound absorption device 5. Furthermore, the partitions 521 each have a height substantially equal to the depth of the cavity 511, in order to be flush with the bottom of the cavity 511, which makes it possible to improve the sound absorption.

As visible in FIG. 5 and in FIG. 6, the acoustically porous nature of the cover 250 is obtained by providing at least one passage 54 passing through the cover 520, so that, once the insert 52 is added and fixed onto the beam 51, the acoustic wave can propagate from the air flow into at least one acoustic cell 53. FIG. 5 and FIG. 6 illustrate that this passage 54 can take the form of orifices 54 extending through the duct wall 50 formed by the cover 520, one of the orifices 54 allowing air circulation from the air flow into a cell 53, another of the orifices 54 allowing air circulation from the air flow into another of the cells 53. More specifically, the cover 520 comprises a rigid layer in which a plurality of through orifices is arranged. This rigid layer can, in one variant (not represented) be surmounted by an acoustically porous flexible layer so that, once the insert is added and fixed onto the beam, the rigid layer obturates the cavities and the flexible layer delimits part of the duct. The flexible layer can take the form of acoustic foam or a mesh pad. In any case, the cover 520 can comprise a rigid portion and/or a flexible portion, which are not necessarily superimposed on each other, but can be juxtaposed, the rigid portion and the flexible portion being in all cases treated so as to be acoustically porous. The rigid layer has a stiffness greater than the stiffness of the flexible layer.

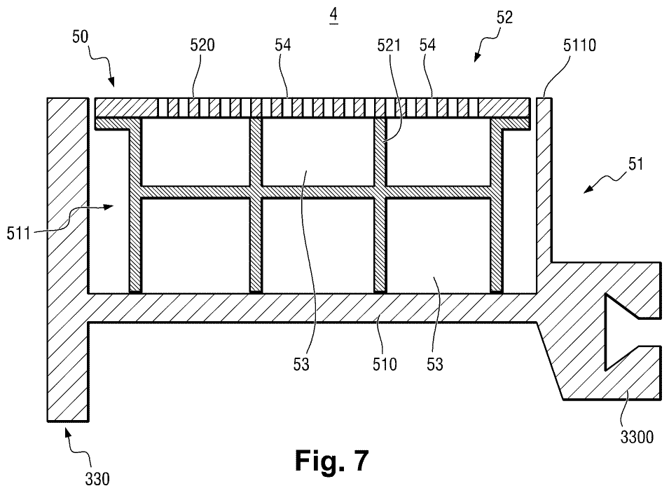

The embodiment illustrated in FIG. 7 is similar to the embodiment illustrated from FIG. 4 to FIG. 6, except that the partition 521 and the cover 520 are not in one piece, the partition 521 being added and fixed onto the cover 520, by any appropriate means, such as an adhesive element, the cover 520 then forming an aeroacoustic skin added onto the structural part formed by the beam 51. This mode of forming the insert 52 makes it possible to provide more flexibility in its design. Furthermore, the insert 52 comprises a plurality of partitions 521 connected to each other and to the cover 520 so as to form two layers (or floors) of distinct closed cells 53, which makes it possible to improve the sound absorption. Typically, the network formed by the partitions 521 can have a honeycomb structure whose sound absorption properties are particularly interesting. In this case, other passages (not represented) can extend through some partitions 521 so that the air taken from the duct wall 50 reaches all the cells 53.

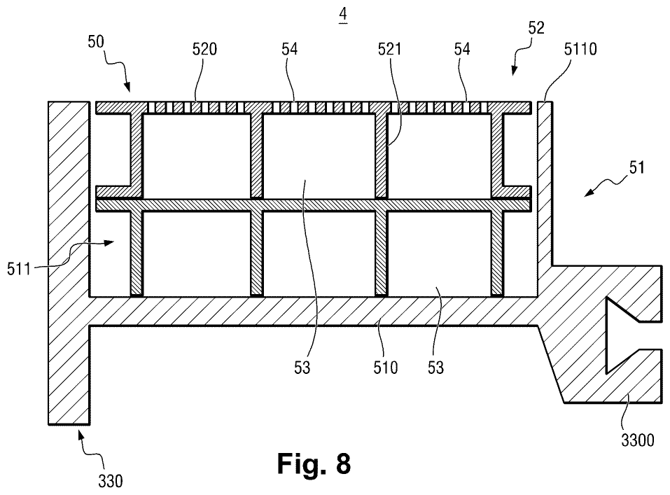

The embodiment illustrated in FIG. 8 is similar to the embodiment illustrated in FIG. 7, except that two inserts 52 are added and fixed onto the support 51, one after the other, like two superimposed cases, each of the inserts 52 comprising a cover 520 and at least one partition 521, the inserts 52 being able to be fixed to each other by any suitable means, such as adhesive. The use of a plurality of inserts 52 gives modularity to the sound absorption device 5 which can be useful for optimizing the sound absorption. In this embodiment, each of the two inserts 52 comprises an acoustically porous cover 520 and a plurality of partitions 521 secured to the cover 520. On the other hand, only one of the inserts 52 obturates all the cavities 511, the other insert 52 being inserted within one of the cavities 511 so that its cover 520 obturates it at least partially, and so that its partitions 521 delimit several acoustic cells 53 within this cavity 511.

The sound absorption device has been described according to different embodiments in which it is associated with a beam of a fixed structure of a thrust reverser of a nacelle of a propulsion assembly for an aircraft. This is however not limiting, since such a sound absorption device can be arranged anywhere in the duct guiding the air flow through the secondary path of the propulsion assembly of an aircraft, as long as it comprises a duct wall delimiting part of the duct, and therefore having a surface in contact with the air flow through which the sound absorption device is capable of capturing part of the air, due to the acoustically porous nature of the duct wall, to trap it in the cells. Typically, the sound absorption device can be arranged within a nacelle of a propulsion assembly for an aircraft which does not comprise a thrust reverser but forms a nozzle for the air stream circulating within the secondary path. Thus, if in the embodiments described, the beam is connected to the rail of the thrust reverser, in the case of a nacelle without thrust reverser, the beam is simply integrated into the nacelle. Moreover, such a sound absorption device can also be arranged in any duct guiding an air flow within the propulsion assembly, without being limited to the secondary path. In fact, any wall delimiting at least in part a duct guiding an air flow through a propulsion assembly for an aircraft can be acoustically treated with the sound absorption device as previously described. By acoustically treating a larger surface of the duct guiding an air flow within a propulsion assembly, typically by means of the absorption device previously described, it is possible to significantly reduce the noise pollution associated with the operation of the aircraft onto which the propulsion assembly is added and fixed.

1-7. (canceled)

8. An assembly comprising:
a duct configured to guide an air flow;
a beam configured to support a movable element of a thrust reverser of an aircraft engine, the beam comprising a wall delimiting a plurality of cavities opened to the air flow; and
an acoustic fairing comprising:
a cover comprising a first layer and a second layer, the second layer being superimposed onto the first layer, the first layer having a first stiffness and the second layer having a second stiffness lower than the first stiffness, a plurality of orifices being provided through the first layer, the second layer being acoustically porous; and
a plurality of partitions secured to the cover;
wherein the acoustic fairing is configured to be added and fixed onto the beam so that the cover delimits a portion of the duct by obturating the plurality of cavities, and so that each of the plurality of partitions extends within one of the plurality of cavities so that the acoustic fairing and the beam delimit a plurality of acoustic cells configured to absorb an acoustic wave propagating from the air flow; and
wherein, once the acoustic fairing is added and fixed onto the beam, the first layer obturates the plurality of cavities and the second layer delimits the portion of the duct.

9. The assembly of claim 8, wherein at least one passage is arranged passing through the cover so that, once the acoustic fairing is added and fixed onto the beam, the acoustic wave can propagate from the air flow to at least one acoustic cell through the at least one passage.

10. The assembly of claim 8, wherein the cover and at least one of the plurality of partitions are in one piece.

11. The assembly of claim 8, wherein at least one of the plurality of partitions is added and fixed onto the cover.

12. The assembly of claim 8, wherein at least one of the plurality of partitions is acoustically porous.

13. The assembly of claim 8, further comprising another acoustic fairing comprising another cover and a plurality of other partitions secured to the other cover, the other acoustic fairing being configured to be added and fixed onto the beam so that the other cover partially obturates one of the plurality of cavities and so that the plurality of other partitions extend within the one of the plurality of cavities, the acoustic fairing being configured to be added and fixed onto the beam so as to be superimposed onto the other acoustic fairing.

14. An aircraft engine comprising the assembly of claim 8 and another wall delimiting another part of the duct.
